(19) United States
(12) Patent Application Publication
(10) Pub. No.: US 2015/0250570 A1
(43) Pub. Date: Sep. 10, 2015

(54) ORAL IRRIGATOR WITH ANTISEPTIC DISPENSER

(71) Applicant: Cadentse LLC, Mesa, AZ (US)

(72) Inventors: Gary B. Persons, Mesa, AZ (US); Gerry Rogers, Black Diamond, WA (US)

(21) Appl. No.: 14/641,371

(22) Filed: Mar. 7, 2015

Related U.S. Application Data
(60) Provisional application No. 61/949,315, filed on Mar. 7, 2014.

(51) Int. Cl. A61C 17/02; A61C 19/06

(52) U.S. Cl. CPC A61C 17/0214; A61C 19/063

(57) ABSTRACT

An oral irrigator that is configured to be connected to a tap, such as a shower tap, is described. In one embodiment, an oral irrigator has a tap manifold for coupling the irrigator between the shower tap and a showerhead. The oral irrigator has an antiseptic port for the introduction of antiseptic into the flow of water from the irrigator tip. In an exemplary embodiment, an irrigator regulator is configured at the irrigator end of a conduit, whereby a user can manipulate an irrigator control feature to control the amount of flow to the irrigator tip. In still another embodiment, an irrigator regulator comprises an antiseptic port and manipulation of an irrigator valve may direct a flow of water to the antiseptic port, thereby introducing a flow of antiseptic out of the irrigator tip.

### CROSS REFERENCE TO RELATED APPLICATIONS

This application claims the benefit of U.S. provisional patent application No. 61/949,315, filed on Mar. 7, 2015, the entirety of which is incorporated by reference herein.

### BACKGROUND OF THE INVENTION

1. Field of the Invention

The present invention relates to an oral irrigator configured to be attached to an existing tap, such as a shower tap, and particularly to an oral irrigator having an antiseptic port for the introduction of antiseptic into the flow of water from the irrigator tip.

2. Background

Oral irrigators are routinely used to remove debris from between and around teeth. Oral irrigators have been shown to provide effective cleaning between teeth and greatly improve oral health. Many people that use an oral irrigator also use an antiseptic. An antiseptic is typically used to flush the mouth after irrigation. Antiseptic may more effectively reach crevices between teeth when dispensed from an irrigator tip however.

Oral irrigators shared by a plurality of users may have to be thoroughly cleaned between uses to reduce the risk of cross-contamination between users. In some cases the head of an irrigator may be completely changed out between users.

Oral irrigators have been described that can be coupled to a shower or sink tap. Theses irrigators however, do not provide a convenient means to introduce an antiseptic into the flow of water exiting the irrigator tip.

There exists a need for an oral irrigator that can be coupled to a sink or shower tap, that can be used by a plurality of users without a cross-contamination risk and that provides a means to quickly and easily introduce an antiseptic into irrigator flow.

### SUMMARY OF THE INVENTION

The invention is directed to an oral irrigator configured to be attached to an existing tap, such as a shower tap, and having an antiseptic port for the introduction of antiseptic into the flow of water from the irrigator tip. In an exemplary embodiment, a shower irrigator is configured to be attached to a tap, such as a shower tap, and comprises a tap manifold for coupling the irrigator between the shower tap and a showerhead. An exemplary tap manifold comprises a tap connector configured to couple to a shower tap, an outlet connector configured to couple to a showerhead, and an irrigator connector configured to couple to an irrigator. The irrigator connector couples an irrigator to the tap manifold and a manifold valve can be manipulated to direct a portion of the flow of water through the tap manifold to an irrigator. A user may adjust the amount of water directed from a tap manifold to an irrigator and thereby affect the water pressure in the irrigator, or the force of spray therefrom. An irrigator comprises a trigger to initiate the flow of water from the tip of the irrigator. In an exemplary embodiment, an irrigator regulator is coupled to the irrigator or at the irrigator end of the conduit, whereby a user can manipulate an irrigator control feature to control the amount of flow to the irrigator tip. In still another embodiment, an irrigator regulator comprises an antiseptic port and manipulation of an irrigator valve may direct a flow of water to the antiseptic port, thereby introducing a flow of antiseptic out of the irrigator tip. In an exemplary embodiment, a user may easily and effectively control the pressure of the irrigator and/or introduce antiseptic all by manipulation of an irrigator control feature.

A tap manifold is configured to be attached to any suitable type of tap, including, but not limited to a sink or shower tap. In an exemplary embodiment, a tap manifold is attached to a shower tap by the tap connector and a showerhead is coupled to the outlet connector of the tap manifold. A irrigator is coupled to the irrigator connector of the tap manifold and a conduit may extend between the tap manifold and the irrigator. All of these connectors may comprise male or female threads to enable the connected portion to be attached to the tap manifold. For example, a tap connector may comprise female pipe threads for connection to the male shower tap threads and the outlet connector may comprise female threads for connection to the showerhead. An irrigator connector may be configured to swivel to provide easier manipulation of a conduit attached thereto. In another embodiment, a conduit comprises a swivel attachment means on one or both ends of the conduit.

In an exemplary embodiment, a tap manifold comprises a manifold valve and manifold control feature, such as a knob, to direct a portion of the flow going through the tap manifold to the irrigator. A manifold control feature may be any suitable type of control feature, such as knob that is coupled to a valve, whereby turning the knob directly turns the valve, or a push-button control, a dial, and the like. In an alternative embodiment, the amount of flow is controlled by an irrigator control feature, such as a knob, and a tap manifold does not comprise a valve. In this embodiment, a flow and pressure of water is automatically directed to the irrigator from the tap manifold.

A tap manifold may also comprise an irrigator retainer, whereby an irrigator and/or irrigator regulator′ can be secured to the tap manifold between uses. Any suitable type of irrigator retainer may be used including, but not limited to, a clamp, a hook or hooks, a magnet, a retainer slot and the like. In addition, a tap manifold may comprise a shower head retainer of any suitable type as aforementioned.

A conduit may be configured between a tap manifold and an irrigator, and may have any suitable length including, but not limited to, more than about 6 inches, more than about 1 ft, more than about 2 ft, more than about 3 ft, more than about 4 ft, and any range between and including the lengths provided. A conduit has a tap manifold end and an irrigator end and one or both of these may be configured with a swivel attachment to provide easier manipulation of the conduit and irrigator. A conduit may comprise a plastic or rubber hose or tube which may be jacketed with a metal, fabric or any other suitable type of jacket. A conduit may comprise a reinforced plastic or rubber hose, wherein a jacket or support material is integrally attached thereto.

An exemplary irrigator regulator is configured to enable a user to control the amount of flow directed to the irrigator nozzle and comprises anir′r′igator valve and an irrigator control feature, such as a knob. An irrigator regulator may be a separate part that is, coupled between the conduit and the irrigator nozzle, or may be integral to the irrigator nozzle, whereby the irrigator nozzle and irrigator regulator are a one-piece unit. An irrigator control feature may be any suitable type of control feature, such as knob that is coupled to an irrigator valve, whereby turning the knob directly turns the valve, or a push-button control, a dial, and the like. An electronic display may be provided to show the pressure, amount of flow, a general output level of water from the irrigator tip, amount of antiseptic incorporation into the water flow and the like. In an exemplary embodiment, the irrigator regulator is configured proximal to the irrigator end of the conduit, or distal from the connection of the conduit with irrigator connector, or manifold. Again, this enables a user to make quick adjustment of the flow and/or antiseptic incorporation without reaching up to make any adjustment to a tap manifold.

An irrigator nozzle comprises an irrigator trigger and an irrigator tip whereby a flow of water is expelled therefrom. An irrigator tngger may be configured as a trigger, a knob, a push-button and the like. An irrigator tip may comprise an elongated extension from the irrigator nozzle, thereby enabling the tip to be positioned within a user's mouth to, effectively direct a stream of water to back portions of their mouth. An irrigator tip may have any suitable shape and size opening. In an exemplary embodiment, an irrigator tip has a substantially circular opening having a diameter of no more than about 1 mm, no more than about 0.5 mm, no more than about 0.25 mm, no more than about 0.1 mm and any range between and including the diameters provided. An irrigator tip may be, any suitable length, such as, about 1 inch or more, about 1.5 inch or more, about 2.0 inch or more, about 3 inches or more, about 5 inches or more and any range between and including the length values provided. An irrigation tip may be curved or angled to enable easier manipulation within a user's mouth and more direct impingement of the irrigator stream to back portions of the mouth. An irrigator tip may be configured to be detachably attached to an irrigator nozzle. An irrigator tip may comprise threads for coupling to the irrigator nozzle, for example.

An oral irrigator, as described herein, may comprise an antiseptic port for the introduction of antiseptic into the flow of water through the irrigator. An antiseptic port may be configured in any suitable location, such as on the tap manifold, along the conduit, and preferably near the end irrigator end of the conduit such as on the irrigator regulator or irrigator nozzle. Put another way, an antiseptic port is preferably configured downstream of the conduit, and more preferably is configured with an irrigator regulator. In an exemplary embodiment, the irrigator regulator comprises an antiseptic port that is configured to receive flow only when a valve is manipulated to direct flow to the antiseptic port. An antiseptic port may allow a user to insert an antiseptic into the oral irrigator, such as by pouring a liquid antiseptic through the port, or by inserting an antiseptic tablet or other solid composition. In another embodiment, an antiseptic container is attached to an antiseptic port and dispenses antiseptic as water flows by and/or into the antiseptic container. For example, a bottle, containing antiseptic and having a threaded portion at an opening to the bottle, may be coupled to an antiseptic port on an irrigator regulator and only when the irrigator control feature is manipulated does the antiseptic enter into the water flowing through the oral irrigator. An irrigator control feature may be manipulated to direct a flow of water past or into an attached antiseptic container. In another embodiment, a separate antiseptic control feature is configured to allow a user to control the amount of flow of antiseptic into the oral irrigator. For example, a valve may be configured at the antiseptic port, or on a portion of the antiseptic container.

An antiseptic port may be configured to allow an antiseptic to be added to any portion of the oral irrigator. For example, an irrigator regulator may be configured with an antiseptic port that is caped or otherwise plugged by a detachable device. The cap or plug may be removed and antiseptic may be poured into the irrigator regulator chamber. Likewise, an antiseptic tablet may be inserted through an antiseptic port and slowly dissolve as water passes by the tablet. An antiseptic port may comprise a slidable member, thereby facilitating addition of antiseptic into the oral irrigator. For example, a slidable member may be configured on an irrigator nozzle and a user may simply slide the member open, insert a tablet and then slide the member back to a closed position. Any suitable type of antiseptic port may be configured, including hinged doors or openings, snap-off portions, push-button release portions and the like.

An oral irrigator, as described herein, may comprise detachable tip covers. A tip cover may be configured to slide down over an irrigator tip and be attached to ensure the tip is not dislodged when water is sprayed from the irrigator tip. For example, a tip cover may be slid down over an irrigator tip and then turned to engage with retainer protrusions, whereby the tip cover cannot be dislodged. In another exemplary embodiment, a tip cover is pushed down over an irrigator tip, whereby the base of the cover expands until a flange seats a lip or edge of an irrigator tip, for example. A tip cover attached in this way may require fracture of the cover material to remove the tip cover from the irrigator tip. One or more tabs may be configured on a tip cover to enable the cover to be removed. In still another exemplary embodiment, a tip cover comprises a curved tip end that may be used to more effectively reach and clean back teeth, for example. In one embodiment, a plurality of tip covers in different colors are provided to allow a plurality of users to select and use a specific color tip.

In one embodiment of the invention, a method of irrigating teeth is provided that comprises the steps of:
a. providing any suitable oral irrigator as described herein;
b. attaching the oral irrigator to a shower tap and attaching a shower head to the outlet connector;
c. initiating a flow of water to the showerhead;
d. manipulating a manifold valve to direct a flow of water to the irrigator nozzle;
e. turning the irrigator control feature of the irrigator regulator to introduce an antiseptic from said antiseptic chamber into the irrigator nozzle;
f. actuating the irrigator trigger to initiate a flow of water and antiseptic from the irrigator tip; and
g. positioning the irrigator tip into a person's mouth to irrigate teeth.

In one embodiment, the method above comprises the step of attaching an antiseptic container to an antiseptic port. In another embodiment, the method above comprises the steps of opening an antiseptic port and introducing an antiseptic, such as a fluid or solid, through the port and closing the port with a port plug, such as a cap.

The summary of the invention is provided as a general introduction to some of the embodiments of the invention, and is not intended to be limiting. Additional example embodiments including variations and alternative configurations of the invention are provided herein.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

### DETAILED DESCRIPTION OF THE ILLUSTRATED EMBODIMENTS

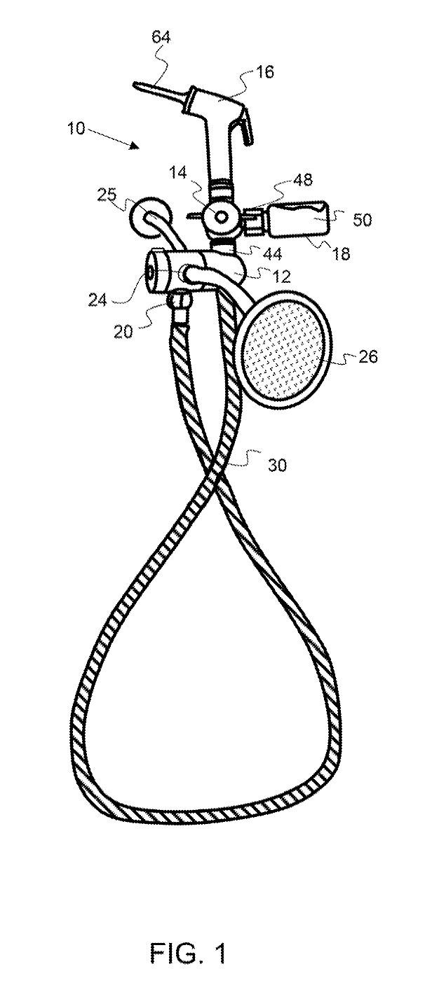

FIG. 1 shows an isometric view of an exemplary oral irrigator coupled to a shower tap and a showerhead attached to the outlet connector of a tap manifold.

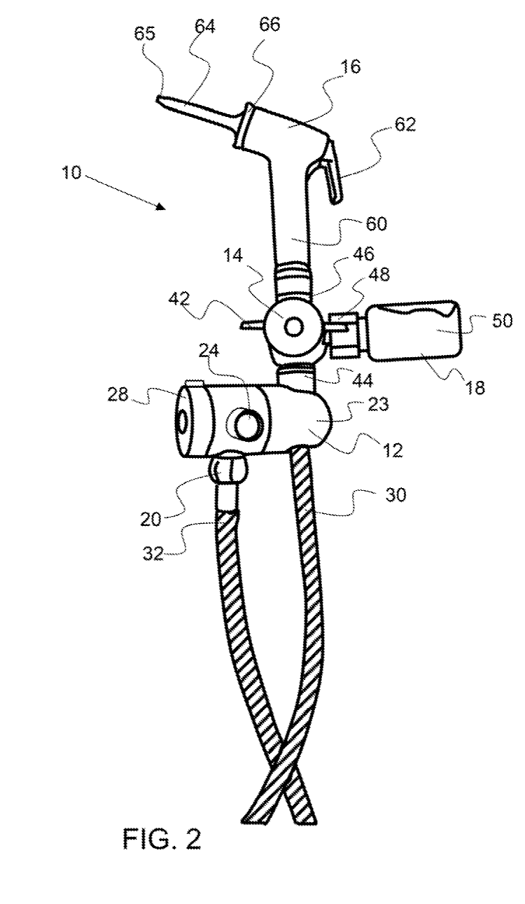

FIG. 2 shows an isometric view of an exemplary oral irrigator having an antiseptic chamber attached to a irrigator regulator.

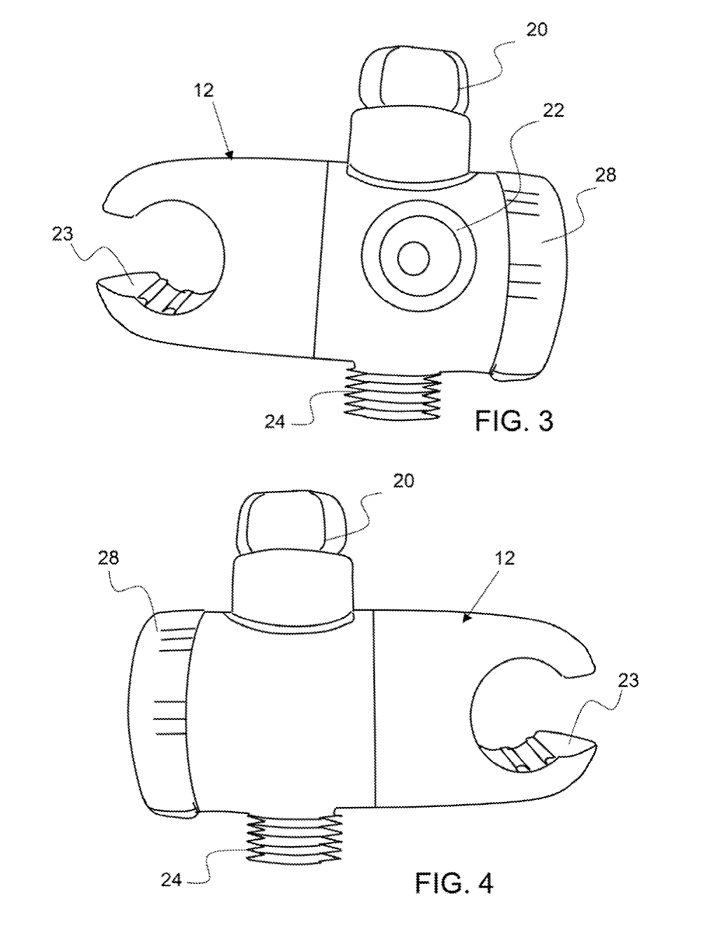

FIG. 3 shows an isometric first side view of an exemplary tap manifold having a tap connector, an outlet connector an irrigator connector and an irrigator retainer.

FIG. 4 shows an isometric second side view of an exemplary tap manifold.

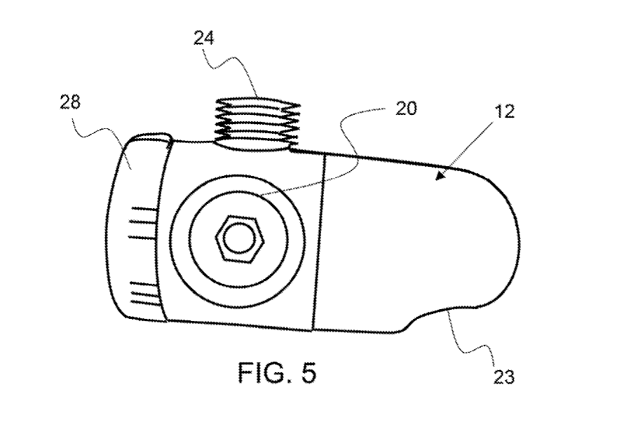

FIG. 5 shows an isometric bottom-up view of an exemplary tap manifold.

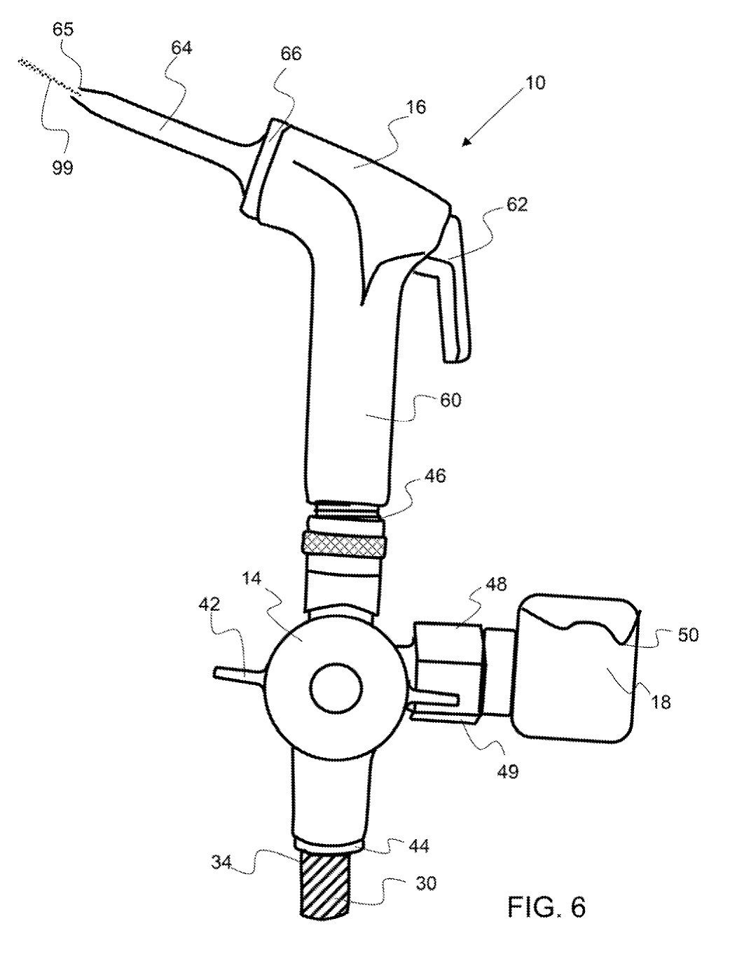

FIG. 6 shows a side view of an exemplary irrigator nozzle attached to an exemplary irrigator regulator.

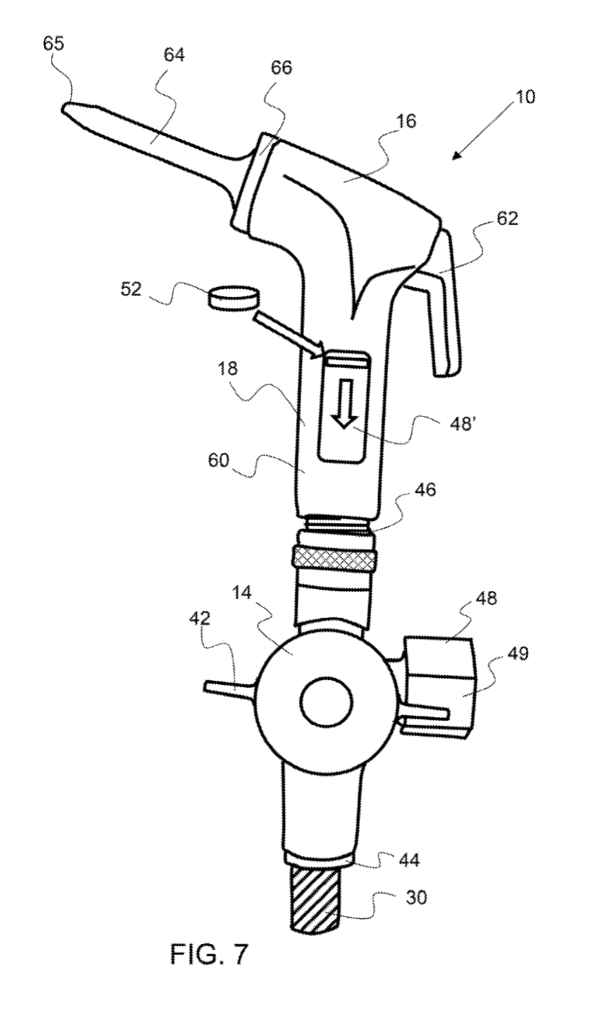

FIG. 7 shows a side view of an exemplary irrigator nozzle having an antiseptic port configured therein.

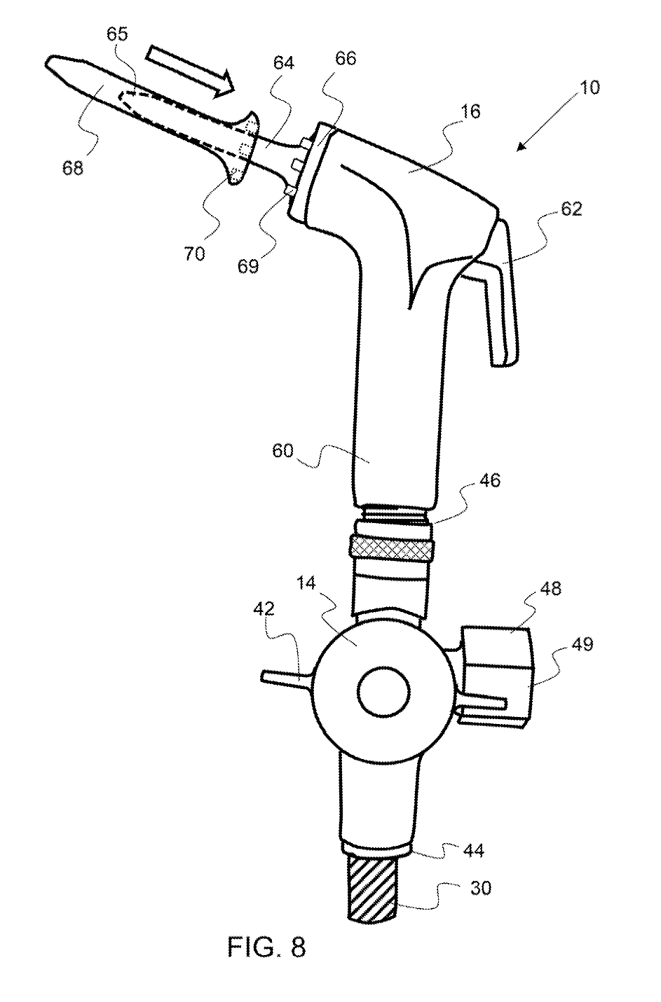

FIG. 8 shows a side view of an exemplary irrigator nozzle attached to an exemplary irrigator regulator and a tip cover being slid down over the irrigator tip.

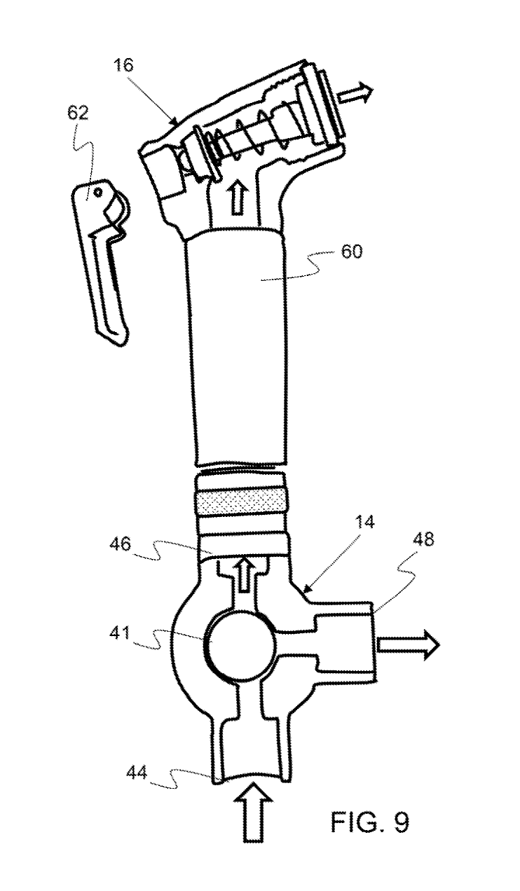

FIG. 9 shows a side view of an exemplary irrigator nozzle having a portion of the nozzle cut-away and an exemplary irrigator regulator having a portion cut-away.

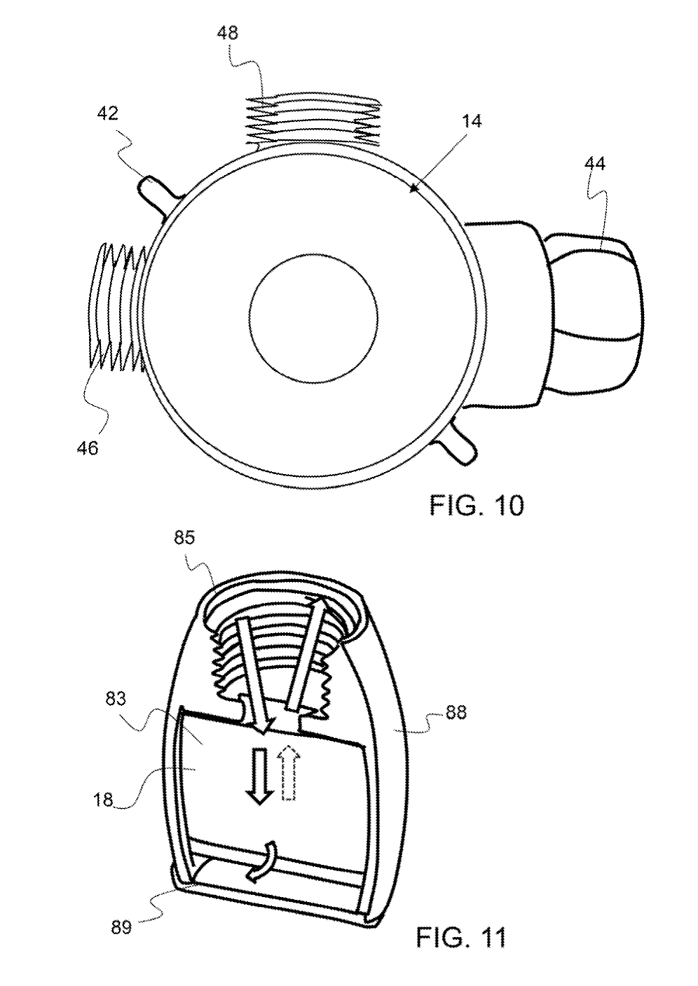

FIG. 10 shows a top-down view of an exemplary irrigator regulator.

FIG. 11 shows a cut-away view of an exemplary antiseptic chamber that is configured for attachment to an antiseptic port.

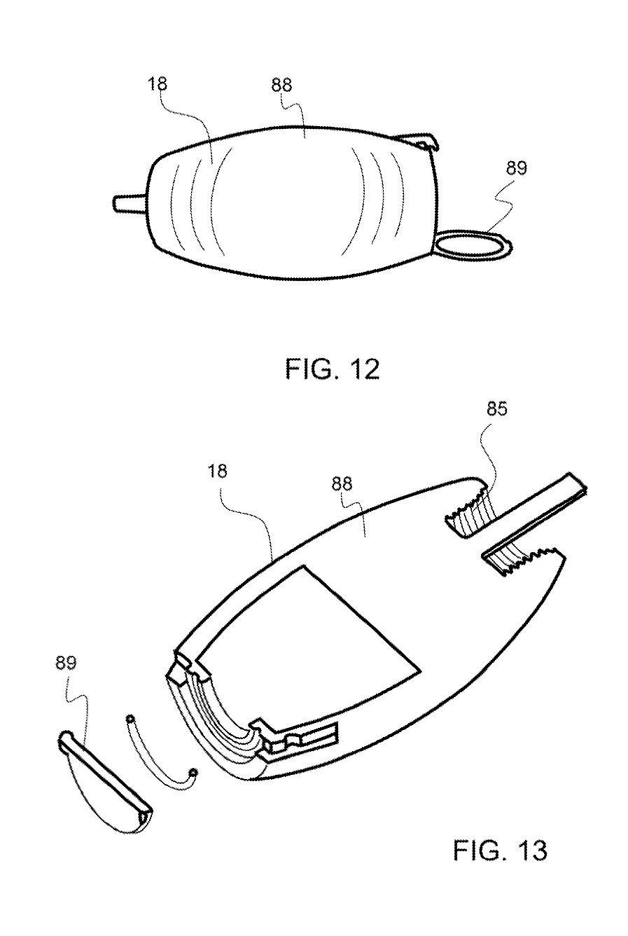

FIG. 12 shows a top-down view of an exemplary antiseptic chamber with an opening feature open.

FIG. 13 shows a cut-away view of an exemplary antiseptic chamber that is configured for attachment to an antiseptic port.

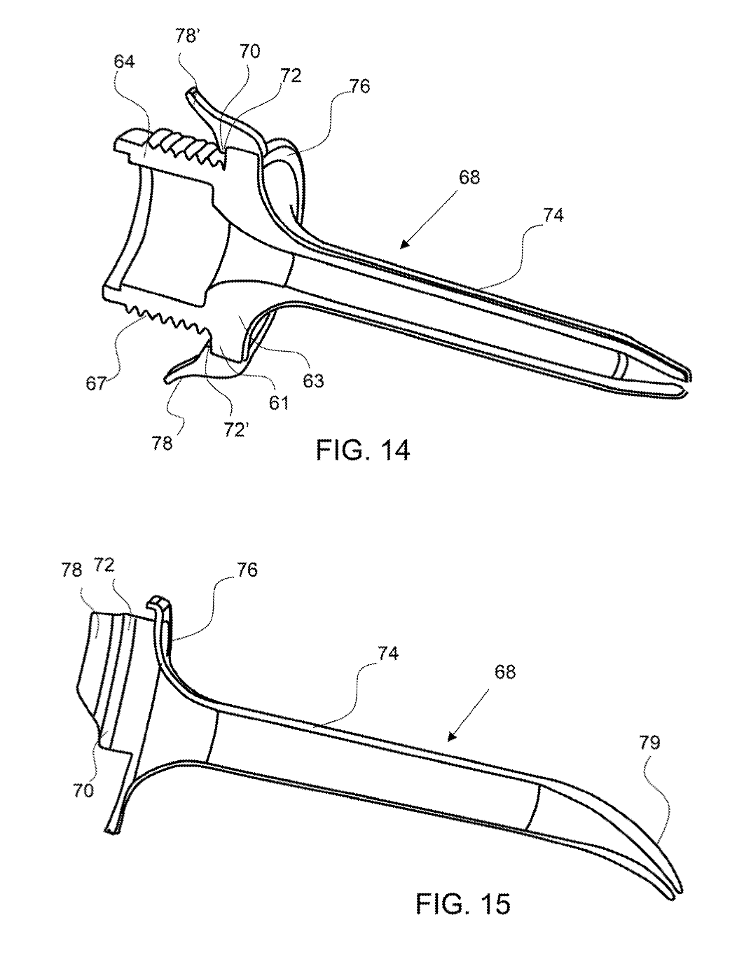

FIG. 14 shows a cut-away view of an exec exemplary irrigator tip cover attached to an irrigator tip.

FIG. 15 shows a cut-away view of an exemplary irrigator tip cover.

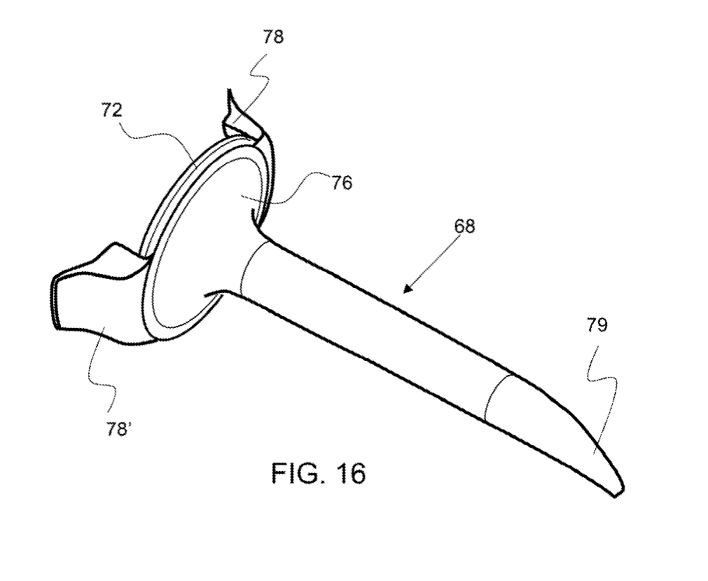

FIG. 16 shows an isometric view of an exemplary irrigator tip cover.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications and improvements are within the scope of the present invention.

As shown in FIG. 1, an exemplary oral irrigator 10 is coupled to a shower tap 25 and a showerhead 26 is attached to the outlet connector 24 of a tap manifold 12. The tap manifold is connected between the shower tap and the shower head. A flexible conduit 30 extends from the irrigator connector 20 to the irrigator regulator 14. An antiseptic chamber 18, a bottle of antiseptic 50, is attached to the antiseptic port 48. The nozzle 16 is attached to the irrigator regulator and has a trigger for spraying irrigate from the tip 64. The location of the antiseptic, distal or downstream of the extended end of the conduit from the tap manifold, enables a user to easily manipulate the flow on antiseptic from the spray nozzle.

As shown in FIG. 2, an exemplary oral irrigator 10 has an antiseptic 50 within a detachable antiseptic chamber 18, a bottle, attached to an irrigator regulator 14. The antiseptic 50 flows from the container through the antiseptic port 48, into the irrigator regulator 14 and finally to the irrigator nozzle 16 where it is sprayed out of the irrigator tip. The conduit 30 has a tap manifold end 32 and an irrigator end, not shown, as it is in the irrigator retainer 23. An irrigator retainer may be an opening, slot or clamp, for example, coupled to the irrigator regulator, or any other suitable means to retain the irrigator. In one embodiment, an irrigator retainer may be provided for retaining the Irrigator in a separate location from the tap manifold, such as on a shower wall. A separate irrigator retainer may comprise a suction cup for attachment to a shower wall.

As shown in FIG. 3, an exemplary tap manifold 12 has a tap connector 22, an outlet connector 24, an irrigator connector 20 and an irrigator retainer 23. The irrigator retainer is a slot in the body of the tap manifold. The outlet connector comprises male threads and the irrigator connector comprises a swivel connection.

As shown in FIG. 4, an exemplary tap manifold 12 comprises a manifold control feature 28 that can be manipulated to direct a flow of water to the irrigator connector 20. The manifold control feature 28, a knob as shown, is coupled with a manifold valve configured within the tap manifold body.

As shown in FIG. 5, an exemplary tap manifold 12 comprises an irrigator connector 20, an outlet connector 24 and a manifold control feature 28.

As shown in FIG. 5, an exemplary irrigator nozzle 16 is attached to an exemplary irrigator regulator 14 by a nozzle attachment 46. The irrigator nozzle comprises a handle 60, a trigger 62, and an irrigator tip 64. The irrigator nozzle 16 shown in FIG. 6 is a pistol grip type of irrigator nozzle, having a trigger 62 configured opposite the irrigator tip 64. The irrigator tip has an attached end 66 and an extended end 65. A tip may be fixed to the nozzle or may be detachably attached. The irrigator regulator 14 comprises a irrigator control feature 42, a knob in this case, and an antiseptic port 48. An antiseptic chamber 18 is attached to the antiseptic port. In this embodiment, an antiseptic regulator 49 is configured at the antiseptic port to control the amount of antiseptic introduced into the flow of water 99 from the irrigator tip 64. The irrigator control feature 42 may also be manipulated in this embodiment to close off any flow of water to the antiseptic port. A user may therefore turn the irrigator control knob to begin the introduction of antiseptic into the flow of water being dispensed, and manipulate the antiseptic regulator 49 to control how much antiseptic they want included in the spray. The irrigator end 34 of the conduit 30 is shown in FIG. 6.

As shown in FIG. 7, an exemplary irrigator nozzle 16 has an antiseptic port 48′ configured therein. The antiseptic port 48′ comprises a slidable member as indicated by the arrow pointing down. A user could slide the antiseptic port open, insert the antiseptic tablet 52 and then close the antiseptic port. The tablet would dissolve as water passes over the tablet in the irrigator nozzle 16. The antiseptic chamber 18 is therefore within the nozzle 16, such as within the nozzle handle 60. It is to be noted that a second antiseptic port 48 is shown being configured on the irrigator regulator 14.

As shown in FIG. 8, an exemplary irrigator nozzle 16 is attached to an exemplary irrigator regulator 14 and a tip cover 68 is being slid down over the irrigator tip 64. A tip cover and an irrigator tip, or other portion of the irrigator nozzle, may be configured to retain the tip cover to ensure that it will not dislodge during use. One or more nozzle retainer features 69 may be configured on the irrigator tip 64, for example, and a corresponding cover retainer feature 70 configured on the tip cover may engage therewith to secure the tip cover to the nozzle 16. A tip cover may have to be slid down over the tip, and then rotated to engage the cover retainer feature 70 with the nozzle retainer feature 69.

As shown in FIG. 9, an exemplary irrigator nozzle 16 has a portion of the nozzle cut-away and an exemplary irrigator regulator 14 has a portion cut-away. The irrigator nozzle comprises a trigger 62 that engages with a plunger within the nozzle head. Squeezing of the trigger pulls the stop configured at the end of the plunger back and allows water to flow through the nozzle head. The irrigator manifold comprises a valve 41 that can direct water coming into the irrigator nozzle from the conduit attachment 44, as depicted by the arrow pointing into the irrigator regulator. The valve can be manipulated to direct water up into the nozzle, through the nozzle attachment 46, or can be turned to direct at least a portion of, the water flow to an antiseptic port 48.

As shown in FIG. 16, an exemplary irrigator regulator 14 comprises a conduit attachment 44, a nozzle attachment 46, and an antiseptic port 48.

As shown in FIG. 11, an exemplary antiseptic chamber 18 is configured for attachment to an antiseptic port by an attachment feature 85. The exemplary antiseptic container shown in FIG. 11 has female threads as an attachment feature; thereby making it an attachable container 88. The container further comprises an opening feature 89, a bottom that opens, thereby allowing an antiseptic to be added to the container while attached to an antiseptic port. A diverter 83 is configured in the antiseptic chamber portion of the detachable chamber and directs the incoming flow of water down and around the diverter. The diverter causes an inflow of water into the antiseptic chamber to flush antiseptic from the chamber.

As shown in FIG. 12, an exemplar antiseptic chamber 18 has an opening feature 89, or door, that can be opened to introduce antiseptic into the chamber. It is to be noted that any suitable type of antiseptic port may be configured on a detachable antiseptic container, including a slidable port, as shown in FIG. 7.

As shown in FIG. 13, an exemplary antiseptic chamber 18 is an attachable container 88. Threads at the attachment end of the attachable container 88 are configured to be threaded onto the oral irrigator, such as to the irrigator regulator.

As shown in FIG. 14, an exemplary tip cover 68 is configured over and attached to an irrigator tip 64. The tip cover comprises a tip cover portion 74, a cover base 76 and a retainer flange 72. The retainer flange seats around an irrigator tip flange 61, or any other suitable lip or edge of the irrigator tip 64. The irrigator tip flange 61 extends circumferentially around the irrigator tip base 63. The tip cover is configured to be pushed down over the irrigator tip, whereby the cover base 76 expands or flexes outward to fit over the irrigator tip base 63. The cover base expands until the interior edge of the cover base fits around the outer portion of the irrigator tip flange 61. The retainer flange 72 then pops around the irrigator tip flange to attach the tip cover to the irrigator tip. The retainer feature 70 of the irrigator tip cover comprises a retainer flange that extends at least partially circumferentially around the cover base and in an exemplary embodiment, extends completely around the circumference of the cover base. The irrigator tip flange may be considered a nozzle retainer feature, as described herein, or a feature that retains a tip cover. The tip cover attachment shown in FIG. 14 provides for secure attachment of the tip cover to the irrigator tip. The tip cover 68 comprises two tabs 78, 78′ that are configured for attachment and removal of the tip cover from the irrigator tip. The tabs may be pulled until the tip cover is detached from the irrigator tip. In an exemplary embodiment, the tip cover is configured to rip when a tab 78 is pulled to detach the tip cover from the irrigator tip and requires the tip cover to be disposed.

As shown in FIG. 15, an exemplary irrigator tip cover 68 comprises a tip cover portion 74, a cover base 76, a retainer flange 72 and a curved tip end 79. A curved tip end may be provided to enable more effective cleaning in the back areas of the mouth. The retainer flange 72 is shown along a portion of a tab 78.

As shown in FIG. 16, an exemplary irrigator tip cover comprises a tip cover portion 74, a cover base 76, a retainer flange 72 and a curved tip end 79. The retainer flange 72 is shown extending completely around the circumference of the tip cover base 76. The two tabs 78, 78′ are shown extending radially out or away from the cover base.

Distal as used herein is in reference to the tap manifold. A conduit attaches to the tap manifold and has an extended or distal end. In addition, a flow of water through the oral irrigator, as described herein, flows downstream from the tap manifold to the outlet of the irrigator.

It will be apparent to those skilled in the art that various modifications, combinations and variations can be made in the present invention without departing from the spirit or scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What claimed is:

1. An oral irrigator comprising:
a. a tap manifold comprising:
i. a tap connector;
ii. an outlet connector;
iii. an irrigator connector;
iv. a manifold valve; and
v. a manifold control feature;
b. a conduit comprising:
i. a tap manifold end; and
ii. an irrigator end;
c. an irrigator regulator configured distal to said irrigator end of said conduit, and comprising:
i. an irrigator valve;
ii. an irrigator control feature; and
d. an irrigator nozzle comprising:
i. an irrigator trigger; and
ii. an irrigator tip; and
e. an antiseptic, port configured distal to said irrigator end of said conduit,
whereby said antiseptic port is configured to provide antiseptic to a flow of water flowing through and out of said irrigator tip.

2. The oral irrigator of claim 1, wherein the tap manifold is configured to attach to a shower tap, whereby the tap connector comprises threads for attachment to said shower tap.

3. The oral irrigator of claim 2, wherein the tap manifold is configured to attach, to a showerhead, whereby the outlet connector comprises threads for attachment to said showerhead.

4. The oral irrigator of claim 3, wherein the tap manifold valve is controlled by the manifold control feature that is configured to open a flow of water to the oral irrigator from a shower tap.

5. The oral irrigator of claim 1, wherein the conduit is two feet long or more.

6. The oral irrigator of claim 1, wherein the irrigator regulator comprises:
a. a conduit attachment; and
b. a nozzle attachment.

7. The oral irrigator of claim 1, wherein the irrigator valve is configured to provide a combined flow comprising a flow of water from the conduit and a flow of antiseptic from an antiseptic chamber that is attached to the antiseptic port.

8. The oral irrigator of claim 1, wherein the antiseptic port comprises a threaded connector.

9. The oral irrigator of claim 1, wherein the antiseptic port comprises a detachable cap, whereby said cap can be detached from said antiseptic port, antiseptic can be introduced through said port and said cap re-attached.

10. The oral irrigator of claim 1, further comprising an antiseptic chamber that is configured to be attached to the antiseptic port.

11. The oral irrigator of claim 1, wherein the antiseptic port comprises a slid able member.

12. The oral irrigator of claim 1, wherein the antiseptic port configured on the irrigator regulator.

13. The oral irrigator of claim 12, wherein are antiseptic chamber is configured within the irrigator regulator.

14. The oral irrigator of claim 1, wherein the antiseptic port is configured on the irrigator nozzle.

15. The oral irrigator of claim 1, further comprising an irrigator tip cover that configured to be detachably attached to the irrigator tip.

16. The oral irrigator of claim 15, wherein the irrigator tip cover comprises:
a. a cover base;
b. a retainer flange that extends at least partially around a circumference of said cover base.

17. The oral irrigator of claim 15, wherein the irrigator tip cover comprises a curved tip end.

18. An oral irrigator comprising:
a. a tap manifold comprising:
i. a tap connector;
ii. an outlet connector;
iii. an irrigator connector;
iv. a manifold valve; and
v. a manifold control feature;
b. a conduit comprising:
i. a tap manifold end; and
ii. an irrigator end;
c. an irrigator regulator configured distal to said irrigator end of said conduit, and comprising;
i. an irrigator valve;
ii. an irrigator control feature; and
iii. an antiseptic port;
d. an irrigator nozzle comprising:
i. an irrigator trigger;
ii. an irrigator tip; and
e. an antiseptic chamber;
whereby said antiseptic chamber is configured to be detachably attached to said antiseptic port.

19. The oral irrigator of claim 18, further comprising an irrigator tip cover that is configured to be detachably attached to the irrigator tip.

20. The oral irrigator of claim 19, wherein the irrigator tip cover comprises:
a. a cover base;
b. a retainer flange that extends at least partially around a circumference of said cover base.

21. The oral irrigator of claim 19, wherein the irrigator tip cover comprises a curved tip end.

22. A method of irrigating teeth comprising:
a. providing an oral irrigator comprising:
i. a tap manifold comprising:
1. a tap connector coupled to a shower tap;
2. an outlet connector coupled to a showerhead;
3. an irrigator connector coupled to a conduit;
4. a manifold valve; and
5, a manifold control feature;
ii. a conduit comprising:
1. a tap manifold end coupled to said irrigator connector; and
2. an irrigator end coupled to an irrigator nozzle;
iii. an irrigator regulator coupled to an irrigator nozzle and comprising;
1. an irrigator valve;
2. a irrigator control feature; and
iv. said irrigator nozzle comprising:
1. an irrigator trigger; and
2. an irrigator tip;
v. an antiseptic port configured distal said irrigator end of said conduit, and
vi. an antiseptic chamber attached to said antiseptic port and comprising an antiseptic;
whereby said antiseptic chamber is configured to provide antiseptic to a flow of water flowing through and out of said irrigator tip;
b. initiating a flow of water to the showerhead;
c. turning said manifold valve to direct a flow of water to said irrigator nozzle;
d. turning said irrigator control feature of said irrigator regulator to introduce said antiseptic from said antiseptic chamber into the irrigator nozzle;
e. actuating said irrigator trigger to initiate a flow of water and antiseptic from the irrigator tip.
f. positioning the irrigator tip into a person's mouth to irrigate teeth.

23. The method of claim 22, wherein the antiseptic chamber comprises an opening feature for the introduction of antiseptic into the antiseptic chamber while the antiseptic chamber is attached to the antiseptic port.
